(19) United States
(12) Patent Application Publication
(10) Pub. No.: US 2012/0123029 A1
(43) Pub. Date: May 17, 2012

(54) Novel aqueous resorcinol-formaldehyde-latex dispersions, a process for production of the said dispersions and use of the said dispersions

(75) Inventors: Wilhelm Laufer, Ellerstadt (DE); Henning Austmann, Dresden (DE); Peter Schuster, Goschenen (CH); Andre Palzer, Bruhl (DE)

(73) Assignee: RHEIN CHEMIE RHEINAU GMBH, Mannheim (DE)

(21) Appl. No.: 13/215,268

(22) Filed: Aug. 23, 2011

(30) Foreign Application Priority Data
Aug. 30, 2010 (EP) 10174547.9
Mar. 16, 2011 (EP) 11158503

(51) Int. Cl. C09J 109/10; C08K 5/29; C09J 109/08; C08K 5/3442

(52) U.S. Cl. 524/86; 524/196

(57) ABSTRACT

The present invention relates to novel aqueous resorcinol-formaldehyde-latex dispersions comprising at least one surface-deactivated diisocyanate, to a process for production of the said dispersions, and to use of the said dispersions for improving adhesion in tyres.

The present invention relates to novel aqueous resorcinol-formaldehyde-latex dispersions comprising at least one surface-deactivated diisocyanate, to a process for production of the said dispersions, and to use of the said dispersions for improving adhesion in tyres.

Resorcinol-formaldehyde-latex dispersions (RFL dip) have become particularly well established in the tyre sector, since they improve the adhesion of the synthetic textile (cord) to the rubber.

However, a disadvantage when polyester is used as cord material is that the adhesion-promoting properties of the RFL dip are inadequate.

Attempts have therefore been made to eliminate the said disadvantage by adding dimeric isocyanates, but these failed because of low performance levels and relatively low shelf life.

When polyester cord is used, isocyanates capped with caprolactams are added (see US A 20080300347) to the RFL dip in order to improve adhesion to the tyre/rubber. A disadvantage of these, in turn, is elimination of caprolactam, which has a disruptive effect in later stages of the process.

EP-A 2159241 moreover discloses the use of microencapsulated dimeric diphenylmethane 4,4′-diisocyanate and diphenylmethane 2,4-diisocyanate (MDI) to improve adhesion-promoting properties. However, disadvantages of the substances described in that document are that they are effective only at temperatures >200° C., high concentrations are needed, and they are expensive and are not available commercially.

It was therefore an object of the present invention to provide aqueous resorcinol-formaldehyde-latex dispersions which do not have the disadvantages of the prior art.

Surprisingly, it has now been found that aqueous resorcinol-formaldehyde-latex dispersions comprising at least one surface-deactivated diisocyanate based on toluene 2,4-diisocyanate (TDI) or on substituted TDI provide excellent adhesion, even at low concentrations.

The present invention therefore provides aqueous resorcinol-formaldehyde-latex dispersions comprising at least one diisocyanate according to formula (I)

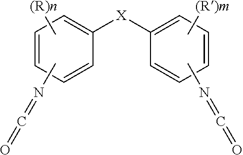

where X═

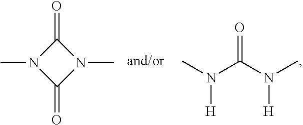

where n and m can be identical or different and are 1, 2, 3 or 4, and R and R′ can be identical or different and are C₁-C₄-alkyl,

which has been surface-deactivated by at least one amine.

In one particular embodiment of the invention, the diisocyanate is a compound of the formula (II)

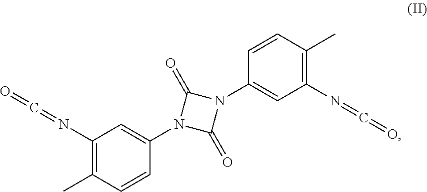

which has been surface-deactivated by at least one amine.

In another, likewise preferred, embodiment of the invention, the diisocyanate is a compound of the formula (III)

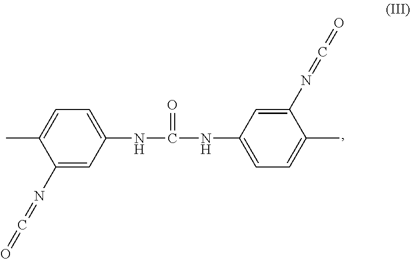

which has been surface-deactivated by at least one amine.

The diisocyanates according to formula (I) are commercially available or can be produced by the processes known to the person skilled in the art, as described for example in J. Prakt. Chem. 1999, 341, no. 7.

The diisocyanates according to formula (II) are commercially available, for example from Rhein Chemie Rheinau GmbH as Addolink® TT or Rhenocure® TT.

The diisocyanates according to formula (III) can be produced by the process known from the prior art, as described for example in DE-A-3438527.

The diisocyanates used are preferably solid and it is particularly preferable that their particle size is <50 μm.

The amine used for the surface-deactivation (microencapsulation) process can comprise any amino-functional compound. These are preferably polyfunctional primary and secondary amines, particularly preferably polyfunctional aliphatic amines. Amines suitable according to the invention are particularly those selected from the group of cyclic and aliphatic, straight-chain or branched (C₂-C₁₄)-alkylamines, -diamines and -polyamines, in particular (C₂-C₁₀)-alkylamines, -diamines and -polyamines, preferably (C₂-C₆)-alkylamines, -diamines and -polyamines, where there can be at least some, or else full, interruption of the alkyl chain by heteroatoms, in particular oxygen or sulphur, and/or where the alkyl chain can comprise further substituents, e.g. hydroxy groups, carboxy groups, halogen or the like.

The following compounds may be mentioned as examples of amines suitable according to the invention: 2-methylpentamethylene-1,5-diamine and its isomers and homologues, e.g. 1,6-hexamethylenediamine; di-sec-butylamine; ethylenediamine; 1,3-propylenediamine; diethylenetriamine; triethylenetetramine; 3,3′-dimethyl-4,4′-diaminodicyclohexylmethane; methylnonanediamine; isophoronediamine; 4,4′-diaminodicyclohexylmethane; alkanolamines and -diamines, e.g. ethanolamine and diethanolamine, and/or amidoamines. Among these, particular preference is given to 2-methylpentamethylene-1,5-diamine and its isomers and homologues, e.g. 1,6-hexamethylenediamine.

These are particularly preferably polyfunctional primary and secondary amines, particularly preferably polyfunctional aliphatic amines, e.g. Jeffamine® T 403 from Huntsman, diisopropanolamine from BASF AG, or amidoamines, such as Versamid® 140 from Cognis, or Euretek 505 from Witco. In particular, these are compounds having hydrophilic groups, e.g. in particular amino groups or hydroxy groups, where these can react with the free isocyanate groups of the solid diisocyanate and thus form a surface coating on the isocyanates, where this then deactivates the isocyanates, examples therefore being amines, diamines and polyamines.

In one preferred embodiment of the invention, the surface deactivation agent used comprises a low-molecular-weight mono-, di- or polyamine having one or more primary and/or secondary amino group(s), the amounts used thereof specifically being such that the degree of deactivation (DD), calculated as ratio of equivalents of amino groups of the surface deactivation agent to the isocyanate groups of the isocyanate requiring deactivation (n NH₂/n NCO), is from 0.9 to 5 equivalent %.

In particular, the molar mass MM of the surface deactivation agent can be 600 g/mol.

Preferred concentrations of surface deactivation agent (amine) here, based on the amount of diisocyanate, are from 1 to 10% by weight, in particular from 2 to 5% by weight.

The surface deactivation process preferably takes place via addition of the amine to an aqueous dispersion of the diisocyanate which optionally also comprises dispersing agent and antisettling agent, with stirring and/or milling. However, it is also possible to carry out the surface deactivation process via addition of the amine to an organic dispersion of the diisocyanate, e.g. to alcohol, toluene, etc.

Commercially available machines can be used for the stirring/milling process, examples being bead mills, dissolvers and/or blade stirrers.

The deactivation of the diisocyanates takes place in a manner known per se, see in particular EP 0 205 970 A and U.S. Pat. No. 4,888,124, the entire content of which is incorporated herein by way of reference, e.g. via:
a) dispersion of the pulverulent solid diisocyanate in a solution of the amine or
b) addition of the amine or of a solution of the amine to a dispersion of the solid fine-particle diisocyanates.

This surface deactivation process can take place in water and/or in organic solvents.

The aqueous dispersion can also comprise further additives, e.g. rheology aids (antisettling agents), e.g. Borchi®Gel ALA (OMG Borchers GmbH) or Kelzan® S obtainable from Monsanto, or else Tragacanth, obtainable from R.T. Vanderbilt, stabilizers. emulsifiers, wetting agents and/or dispersing agents, e.g. Tamol® NN 9104 from BASF AG or Aerosol® OT45 from Cytec Surface Specialities GmbH, or Dispersogen® HR from Clariant International Ltd.

For the purposes of the invention, the resorcinol-formaldehyde-latex dispersion is a dispersion of the individual components resorcinol and formaldehyde, and/or formaldehyde together with a precondensate made of resorcinol and formaldehyde (e.g. Rhenosin® T from Rhein Chemie Rheinau GmbH and Penacolite® 50 obtainable from Indspec Chemical Corp.) and of one or more of the latex dispersions mentioned hereinafter.

The latex dispersion used for the purposes of the invention can be any of the latices known in the prior art, e.g. XSBR latex (carboxylated styrene-butadiene copolymers), HSSBR latex (styrene-butadiene copolymers), nitrile-butadiene copolymers (NBR latex), CR latex (polychloroprene), PSBR latex (pyridine-styrene-butadiene copolymers) and/or acrylate latex (acrylate-only copolymers and styrene-acrylate copolymers) and/or styrene-butadiene-vinylpyridine copolymer latices, preference being given to styrene-butadiene-vinylpyridine copolymer latices (e.g. Pliocord VP 106, obtainable from Eliochem). These are commercially available substances obtainable by way of example from Polymer Latex GmbH or from Eliokem.

The resorcinol-formaldehyde-latex dispersion here is preferably obtained via stirring to incorporate a basic aqueous mixture made of resorcinol and formaldehyde, or preferably a basic aqueous mixture made of formaldehyde and of the precondensate of resorcinol and formaldehyde, in a basic aqueous latex mixture.

The ratio of resorcinol to formaldehyde is preferably from 1:1 to 2.5:1.

The ratio of latex to the condensate made of resorcinol and formaldehyde, based on solids content thereof, is preferably from 10:1 to 4:1, particularly preferably 6:1.

The aqueous basic solutions used are preferably aqueous Na hydroxide and/or ammonium hydroxide solutions. Preferred pHs here are from 10 to 11.

The amounts preferably used of the surface-deactivated diisocyanates here are from 0.5 to 10%, particularly from 5 to 8%, based on the solids content in the resorcinol-formaldehyde-latex dispersion.

The present invention further provides a process for producing aqueous resorcinol-formaldehyde-latex dispersions, where, for the surface-deactivation process, at least one diisocyanate according to the formulae (I) to (III) is deactivated by at least one amine either
a) via dispersion of at least one pulverulent diisocyanate according to the formulae (I) to (III), preferably solid diisocyanate, in a solution of at least one amine or
b) via addition of at least one amine or one solution of at least one amine to a dispersion of at least one of the diisocyanates according to the formulae (I) to (III), and then

is incorporated by stirring into the resorcinol-formaldehyde-latex dispersion, or the resorcinol-formaldehyde-latex dispersion is incorporated by stirring into these solutions from a) or b).

Commercially available mixing assemblies, e.g. stirred vessels and dispersers, are used here to incorporate the deactivated diisocyanates by stirring into the resorcinol-formaldehyde-latex dispersion, or to incorporate the resorcinol-formaldehyde-latex dispersion by stirring into the deactivated diisocyanates.

The present invention further provides adhesive formulations comprising at least one aqueous resorcinol-formaldehyde-latex dispersion according to the invention and also one activator.

Examples of activators for the purposes of the invention are epoxides, such as glycidyl ether GE 500 from Raschig, or Bisphenol A Epoxynovolac from Editya Birla Chemical, etc,

To produce the adhesive formulations here, the resorcinol-formaldehyde-latex dispersions are mixed with the surface-deactivated diisocyanate and the activator is then added, but other addition sequences are not excluded.

The present invention further provides processes for improving the adhesion of reinforcement fibres to crosslinked rubber or to elastomers, where the reinforcement fibres (fibres, cord) are introduced into the adhesive formulation according to the invention and are then dried, or

the reinforcement fibres (fibres, cord) are treated in one or more steps with one or more of the constituents of the adhesive formulation according to the invention.

In particular in the case of the last-mentioned treatment in a plurality of steps then using one or more constituents of the adhesive formulation according to the invention, the fibre can also be subjected to intermediate drying.

To the extent that the abovementioned process according to the invention is carried out in a plurality of steps using one or more constituents of the adhesive formulation according to the invention, examples of possible embodiments are as follows:

by way of example, the reinforcement fibre can first be introduced into at least one epoxide and optionally dried, and then introduced into the resorcinol-formaldehyde-latex dispersion using at least one diisocyanate of the formula (I), (II) and/or (III) which has been surface-deactivated by an amine or

the reinforcement fibre is first introduced into a dispersion made of at least one epoxide and of at least one diisocyanate of the formula (I), (II) and/or (III) which has been surface-deactivated by an amine, and is optionally dried, and then is introduced into a latex dispersion which also comprises resorcinol and formaldehyde, or formaldehyde and a resorcinol-formaldehyde precondensate.

The crosslinked rubber or the elastomer here is preferably styrene-butadiene rubber (SBR rubber), butadiene rubber (BR rubber), natural rubber (NR rubber), synthetic natural rubber (IR rubber), polyurethane elastomers, or any mixture thereof.

In the abovementioned cases it is possible to use either preactivated (pretreated) reinforcement fibres or else non-preactivated reinforcement fibres.

The preactivated (pretreated) reinforcement fibres are by way of example polyester- or aramid-based fibres which during their production (spinning) have been treated with a size. Examples of commercially available products are KoSa 793 and KoSa 748 from KoSa. In many cases, the sizes comprise epoxides.

The non-pretreated reinforcement fibres are by way of example polyester- or aramid-based fibres. An example of commercially available products is KoSa 792.

This invention also includes a process for improving the adhesion of reinforcement fibres to crosslinked rubber or to elastomers, where preactivated (pretreated) reinforcement fibres are introduced into the aqueous resorcinol-formaldehyde-latex dispersion according to the invention and are then dried.

For the purposes of the invention, the term fibres means not only fibres but also yarns, cord, and also reinforcement textiles, based by way of example on polyester or aramid, e.g. inter alia polyethylene-terephthalate-based fibres.

The present invention also provides adhesion-improved fibres obtainable by bringing the activator-pretreated fibres into contact with at least one aqueous resorcinol-formaldehyde-latex dispersion according to the invention, or by bringing a non-pretreated fibre into contact with at least one adhesive formulation according to the invention, and subsequent drying (setting) at temperatures >180° C.,

The present invention further provides the use of the resorcinol-formaldehyde-latex dispersion according to the invention optionally in the presence of activators for improving adhesion of reinforcement fibres to crosslinked rubber or to elastomers in tyres, drive belts, conveyor belts and/or hoses.

The invention also provides the use of the adhesive formulation according to the invention for improving adhesion of reinforcement fibres to crosslinked rubber or to elastomers in tyres, drive belts, conveyor belts and/or hoses.

The invention also includes a process for forming tyres, drive belts, conveyor belts and/or hoses comprising the steps of adding the adhesion-improved reinforcement fibres according to the invention to said tyres, drive belts, conveyor belts and/or hoses.

The following examples serve to illustrate the invention, but without any resultant limiting effect.

### INVENTIVE EXAMPLES

Chemicals used:

Addolink® TT, diisocyanate based on toluene 2,4-diisocyanate (TDI-uretdione), obtainable from Rhein Chemie Rheinau GmbH,

Grilbond® IL 6, caprolactam-capped MDI (diphenylmethane 4,4-diisocyanate), 50% dispersion, obtainable from EMS-Griltech,

MDI-U, dimeric MDI (diphenylmethane 4,4′-diisocyanate and/or diphenylmethane 2,4-diisocyanate), produced according to EP 219 241 A,

Tamol® NN 9104, wetting/dispersing agent, obtainable from BASF AG,

Borchi Gel® L 75, antisettling agent, obtainable from OMG Borchers GmbH,

Jeffamin® T 403, polyetheramine, obtainable from Huntsman International LLC,

tragacanth thickener (1% in water), obtainable from R.T. Vanderbilt,

GE 500 glycidyl ether, obtainable from Raschig GmbH,

Penacolite® 50, a resorcinol-formaldehyde precondensate, obtainable from Indspec Chemical Corp,

Pliocord® VP 106, a styrene-butadiene-vinylpyridine copolymer latex with 41% solids content, obtainable from Eliokem,

HMLS polyester fibres are high-modulus low-shrinkage polyester fibres from Polyester High Performance GmbH,

LS polyester fibres are (LS) low-shrinkage polyester fibres from Polyester High Performance GmbH.

Table 1 collates the amounts used to produce an aqueous dispersion:

TABLE 1

| Material | Ex. 1 | Ex. 2 | Ex. 3 |
|---|---|---|---|
| Addolink ® TT | 100 | | |
| MDI-U | | 100 | |
| Grilbond ® IL 6 | | | 100 |
| Tamol ® NN 9104 | 4.4 | 4.4 | |
| Water | 85.6 | 85.6 | |
| Borchi Gel ® L 75 | 0.5 | 0.5 | |
| Jeffamin ® T 403 | 2.0 | 2.0 | |

The amounts used have been stated in parts by weight.

The method of producing the aqueous dispersions here was as follows:

Water and wetting/dispersing agent (Tamol® NN 9104) were combined and dissolved/mixed. Depending on the respective example, Addolink® TT or MDI-U was then added and the mixture was homogenized in a dissolver, Jeffamin® T 403 was then added for surface-deactivation and incorporated by mixing with avoidance of shear forces. Borchi Gel® L 75 was then incorporated by mixing, and the mixture was homogenized.

Table 2 gives the constitutions of adhesive formulations for treating preactivated polyester fibres:

TABLE 2

| Material | Ex. 4 (inv) | Ex. 5 (CE) | Ex. 6 (CE) |
|---|---|---|---|
| Aqueous Addolink ® TT | 28 | | |
| dispersion according to Ex. 1 | | | |
| (surface-deactivated) | | | |
| Aqueous MDI-U dispersion | | 28 | |
| according to Ex. 2 (surface- | | | |
| deactivated) | | | |
| Aqueous Grilbond ® IL 6 | | | 28 |
| dispersion according to Ex. 3 | | | |
| Water | 367.3 | 367.3 | 395.3 |
| Sodium hydroxide (10%) | 6 | 6 | 6 |
| Penacolite ® 50 | 42.4 | 42.4 | 42.4 |
| Formaldehyde (37%) | 20.5 | 20.5 | 20.5 |
| Pliocord VP 106 | 411 | 411 | 411 |
| Ammonia (25%) | 24.7 | 24.7 | 24.7 |

CE = comparative example,
inv = according to the invention;
the amounts used have been stated in parts by weight

The treated fibres were predried at about 135° C. for about 60 s, and the setting process took 120 s at temperatures of >180° C.

Vulcanization and adhesion testing were carried out according to ASTM D 4393. The test elastomer mixture used was Dunlop SP 5320.

It was apparent that the fibres treated with the TDI-based diisocyanates surface-deactivated by the process according to the invention have very good adhesion to crosslinked rubber and to elastomers, even when the setting temperature is >180° C. In contrast to this, the fibres treated with caprolactam-capped MDI or with surface-deactivated MDI uretdione exhibit poorer adhesion.

Table 3 shows the results of the adhesion tests when using preactivated HMLS polyester fibres:

TABLE 3

| | | Examples | | |
|---|---|---|---|---|
| | | Ex. 4 | | |
| Test* | Unit | (inv) | Ex. 5 | Ex. 6 |
| Strap peel test | % | <10 | <10 | <10 |
| (degree of cover) | | | | |
| Strap peel test | N/2.5 cm | 310-320 | 270-280 | 260-270 |
| (adhesion) | | | | |

*Setting temperature 235° C.

Table 4 shows the results of the adhesion tests when using preactivated LS polyester fibres:

TABLE 4

| | | Examples | | |
|---|---|---|---|---|
| | | Ex. 4 | | |
| Test* | Unit | (inv) | Ex. 5 | Ex. 6 |
| Strap peel test | % | 10 to 20 | <10 | <10 |
| (degree of cover) | | | | |
| Strap peel test | N/2.5 cm | 330-340 | 290-300 | 270-280 |
| (adhesion) | | | | |

*Setting temperature 235° C.

Table 5 shows the results of the adhesion tests when using non-preactivated HMLS polyester fibres with use of a two-stage dip process and, respectively, of the coupling agent in the pre-dip process:

TABLE 5

| | | Coupling agent | | |
|---|---|---|---|---|
| | | | | Grilbond ® |
| Test* | Unit | Addolink ® TT | MDI-U | IL6 |
| Strap peel test | % | <10 | <10 | <10 |
| (degree of cover) | | | | |
| Strap peel test | N/2.5 cm | 290-300 | 250-260 | 190-200 |
| (adhesion) | | | | |

*Setting temperature for pre-dip process: about 180° C., setting temperature for RFL-dip process: 235° C.

What is claimed is:

1. Aqueous resorcinol-formaldehyde-latex dispersion comprising at least one diisocyanate according to formula (I) 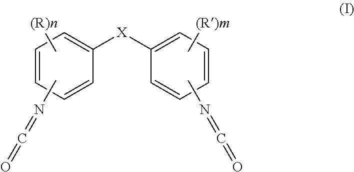
where X═ 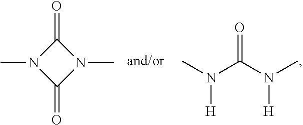
where n and m can be identical or different and are 1, 2, 3 or 4, and R and R′ can be identical or different and are C₁-C₄-alkyl,
which has been surface-deactivated by at least one amine.

2. Aqueous resorcinol-formaldehyde-latex dispersion according to claim 1, characterized in that the diisocyanate is a compound of the formula (II) 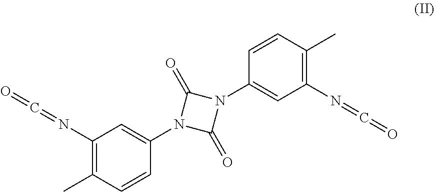
which has been surface-deactivated by at least one amine.

3. Aqueous resorcinol-formaldehyde-latex dispersion according to claim 1 or 2, characterized in that the diisocyanate is a compound of the formula (III) 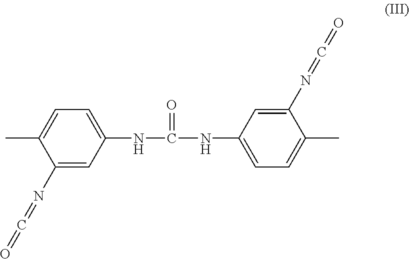
which has been surface-deactivated by at least one amine.

4. Aqueous resorcinol-formaldehyde-latex dispersion according to one or more of claims 1 to 3, characterized in that the resorcinol-formaldehyde-latex dispersion involves a dispersion of the individual components resorcinol and formaldehyde, and/or formaldehyde together with a precondensate made of resorcinol and formaldehyde and of one or more of the latex dispersions selected from the following group: carboxylated styrene-butadiene copolymers (XSBR latex), nitrile-butadiene copolymers (NBR latex), polychloroprene (CR latex), pyridine-styrene-butadiene copolymers (PSBR latex) and/or acrylate-only copolymers and/or styrene-acrylate copolymers (acrylate latex) and/or styrene-butadiene-vinylpyridine copolymer latices.

5. Process for producing aqueous resorcinol-formaldehyde-latex dispersions according to one or more of claims 1 to 4, characterized in that, for the surface-deactivation process, at least one diisocyanate according to the formulae (I) to (III) is deactivated by at least one amine either
a) via dispersion of at least one pulverulent diisocyanate according to the formulae (I) to (III) in a solution of at least one amine or
b) via addition of at least one amine or one solution of at least one amine to a dispersion of at least one of the diisocyanates according to the formulae (I) to (III), and then
is incorporated by stirring into the resorcinol-formaldehyde-latex dispersion, or the resorcinol-formaldehyde-latex dispersion is incorporated by stirring into these solutions from a) or b).

6. Adhesive formulation, comprising an aqueous resorcinol-formaldehyde-latex dispersion according to one or more of claims 1 to 4 and also an activator.

7. Adhesive formulation according to claim 6, characterized in that the activator is at least one epoxide.

8. Process for improving the adhesion of reinforcement fibres on crosslinked rubber or to elastomers, characterized in that
the fibres are introduced into an adhesive formulation according to claims 6 or 7 and are then dried, or
the fibres are treated in one or more steps with one or more of the constituents of the adhesive formulation according to claims 6 or 7.

9. Process for improving the adhesion of reinforcement fibres on crosslinked rubbers or on elastomers, characterized in that the preactivated fibres are introduced into an aqueous resorcinol-formaldehyde-latex dispersion according to claims 1 to 4 and are then dried.

10. Adhesion-improved fibres, obtainable by bringing the activator-pretreated fibres into contact with at least one aqueous resorcinol-formaldehyde-latex dispersion according to one or more of claims 1 to 4, or by bringing a non-pretreated fibre into contact with at least one adhesive formulation according to claim 6 or 7, and subsequent drying (setting) at temperatures of >180° C.

11. Process according to claims 8 or 9 for improving adhesion of reinforcement fibres to crosslinked rubber or to elastomers in tyres, drive belts, conveyor belts and/or hoses.
